(19) United States
(12) Patent Application Publication
(10) Pub. No.: US 2026/0204192 A1
(43) Pub. Date: Jul. 16, 2026

(54) IMAGE MONITORING SYSTEM AND IMAGE DETECTING METHOD THEREOF

(71) Applicant: Wistron Corporation, New Taipei City (TW)

(72) Inventor: Chen Yu Chan, New Taipei City (TW)

(73) Assignee: Wistron Corporation, New Taipei City (TW)

(21) Appl. No.: 19/059,121

(22) Filed: Feb. 20, 2025

(30) Foreign Application Priority Data
Jan. 16, 2025 (TW) 114101775

(51) Int. Cl. G09G 3/00; G09G 5/00

(52) U.S. Cl. CPC G09G 3/006; G09G 5/003; G09G 2330/12

(57) ABSTRACT

An image monitoring system and an image detecting method thereof are provided. A first data check code value is provided according to an output image signal that is output. The first data check code value is compared with a second data check code value provided by a driver circuit according to an output image signal that is received, so as to confirm correctness of the output image signal that is received by the driver circuit.

### CROSS-REFERENCE TO RELATED APPLICATION

This application claims the priority benefit of Taiwan application serial no. 114101775, filed on Jan. 16, 2025. The entirety of the above-mentioned patent application is hereby incorporated by reference herein and made a part of this specification.

### BACKGROUND

### Technical Field

The present invention relates to a monitoring system, and particularly relates to an image monitoring system and image detecting method thereof.

### Related Art

Due to high security requirements for automotive monitoring products, there is a high demand for accuracy of content of monitoring image frames. It is necessary to ensure that displayed monitoring image frames will not have phenomena such as fragmentation, color distortion, or snow-like noise due to circuit abnormalities. However, current monitoring devices do not have the function of verifying image signals, and therefore cannot meet the requirements for the accuracy of monitoring images.

### SUMMARY

The present invention provides an image monitoring system and image detecting method thereof, which may effectively detect the accuracy of image signals of the image

The image monitoring system of the present invention includes a display device, a processing circuit, a driving circuit, and a control circuit. The processing circuit generates an output image signal based on an input image signal. The driving circuit is coupled to the display device and drives the display device to display a monitoring image according to the output image signal. The processing circuit provides a first data check code value based on the output image signal of the processing circuit, and compares the first data check code value with a second data check code value provided by the driving circuit, the second data check code value is provided based on the output image signal received by the driving circuit. The control circuit is coupled to the processing circuit, and in response to the first data check code value being different from the second data check code value, the control circuit closes the display device.

In an embodiment of the present invention, the processing circuit includes a processor and a timing controller. The processor is coupled to the control circuit. The timing controller is coupled to the processor, generates the output image signal based on the input image signal, calculates the first data check code value, and the processor or the timing controller compares the first data check code value with the second data check code value. In response to the first data check code value being different from the second data check code value, the processor notifies the control circuit to close the display device.

In an embodiment of the present invention, the output image signal includes a preset pattern image, the first data check code value is a preset data check code value corresponding to the preset pattern image, and the driving circuit provides the second data check code value based on the preset pattern image.

In an embodiment of the present invention, the preset pattern image is an On-Screen Display image, and the timing controller superimposes the preset pattern image on the input image signal to generate the output image signal.

In an embodiment of the present invention, the preset pattern image is displayed in a display area of the display device that is blocked by a mechanical component.

In an embodiment of the present invention, the preset pattern image is an image with a highest grayscale value or a lowest grayscale value.

In an embodiment of the present invention, after the control circuit closes the display device, the display area of the display device presents a mirror surface.

In an embodiment of the present invention, the control circuit is an embedded controller.

The present invention also provides an image detecting method of an image monitoring system. The image monitoring system includes a display device. The image detecting method of the image monitoring system includes the following steps. Generating an output image signal to a driving circuit based on an input image signal. Providing a first data check code value based on the output image signal that is output. Comparing the first data check code value with a second data check code value provided by the driving circuit, the second data check code value is provided based on the output image signal received by the driving circuit. In response to the first data check code value being the same as the second data check code value, controlling the driving circuit to drive the display device to display a monitoring image based on the output image signal. In response to the first data check code value being different from the second data check code value, closing the display device.

In an embodiment of the present invention, the first data check code value may be calculated based on the output image signal that is output.

In an embodiment of the present invention, the output image signal includes a preset pattern image, the first data check code value is a preset data check code value corresponding to the preset pattern image, and the driving circuit provides the second data check code value based on the preset pattern image.

In an embodiment of the present invention, the preset pattern image is an On-Screen Display image, and the image detecting method of the image monitoring system includes superimposing the preset pattern image on the input image signal to generate the output image signal.

In an embodiment of the present invention, the preset pattern image may be displayed in the display area blocked by mechanical components of the display device.

In an embodiment of the present invention, the preset pattern image may have the highest grayscale value or the lowest grayscale value.

In an embodiment of the present invention, after the control circuit closes the display device, the display area of the display device may present a mirror surface.

Based on the above, the embodiment of the present invention may provide a first data check code value according to the output image signal, and compare the first data check code value with a second data check code value provided by the driving circuit based on a received output image signal, to confirm correctness of the output image signal received by the driving circuit, thereby ensuring that the driving circuit drives the display device to display the correct image frame according to the output image signal.

### BRIEF DESCRIPTION OF THE DRAWINGS

FIG. 1 is a schematic diagram of an image monitoring system according to an embodiment of the present invention.

FIG. 2 and FIG. 3 are timing diagrams illustrating the operation of the image monitoring system according to embodiments of the present invention.

FIG. 4 is a schematic diagram of the display area of the display device in the image monitoring system according to an embodiment of the present invention.

FIG. 5 and FIG. 6 are timing diagrams illustrating the operation of the image monitoring system according to embodiments of the present invention.

FIG. 7 is a flowchart of an image detecting method of the image monitoring system according to an embodiment of the present invention.

### DESCRIPTION OF THE EMBODIMENTS

To make the content of the present invention more easily understood, embodiments are provided below as examples that can be actually implemented according to the present invention. In addition, where possible, components/elements/steps with the same reference numbers in the figures and embodiments represent the same or similar parts.

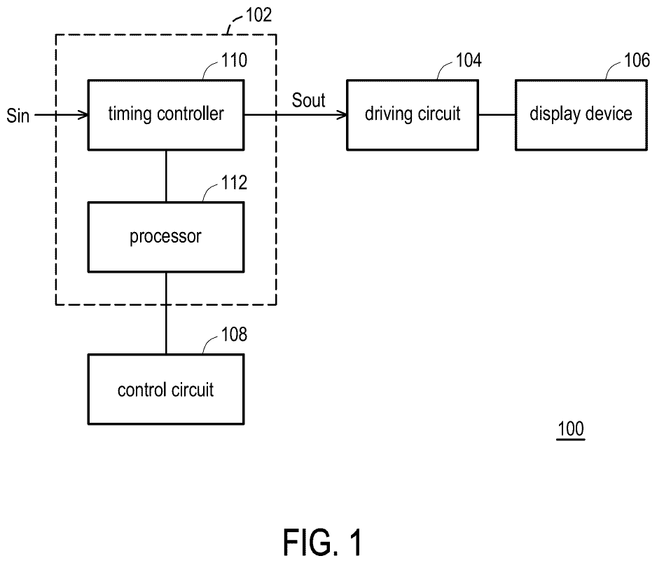

Please refer to FIG. 1 below. FIG. 1 is a schematic diagram of an image monitoring system according to an embodiment of the present invention. The image monitoring system 100 may include a processing circuit 102, a driving circuit 104, a display device 106, and a control circuit 108. The processing circuit 102 is coupled to the driving circuit 104 and the control circuit 108, and the display device 106 is coupled to the driving circuit 104.

The processing circuit 102 may receive an input image signal Sin, generate an output image signal Sout based on the input image signal Sin, and calculate a data check code value (for example, CRC code) of the output image signal Sout that is output by the processing circuit 102, so as to generate a first data check code value. The driving circuit 104 may drive the display device 106 to display a monitoring image according to the output image signal Sout, and calculate the output image signal Sout that is received by the driving circuit 104, so as to generate a second data check code value to the processing circuit 102. The processing circuit 102 may compare the first data check code value with the second data check code value to ensure that the output image signal Sout received by the driving circuit 104 is the same as the output image signal Sout output by the processing circuit 102.

When the processing circuit 102 determines that the first data check code value is the same as the second data check code value, it represents that the output image signal Sout received by the driving circuit 104 is the same as the output image signal Sout output by the processing circuit 102. The driving circuit 104 may then normally drive the display device 106 to display the monitoring image according to the output image signal Sout. When the processing circuit 102 determines that the first data check code value is different from the second data check code value, it represents that the output image signal Sout received by the driving circuit 104 is different from the output image signal Sout output by the processing circuit 102. In this case, the processing circuit 102 may notify the control circuit 108 (for example, an embedded controller, but not limited to this) that an abnormality has occurred in the monitoring image. The control circuit 108 may then close the display device 106 to avoid providing erroneous monitoring images to the user. In some embodiments, when the display device 100 is displaying normally, it may display the monitoring image in the display area, and when the display device 100 is closed, the display device 100 may provide a mirror surface in the display area to prevent erroneous monitoring images from affecting the security of the image monitoring system. For example, the display device 100 may be a display device with a semi-transparent mirror in the display area. The display device 100 may be, for instance, a rearview mirror for a car or motorcycle, or a safety traffic mirror, but is not limited to these.

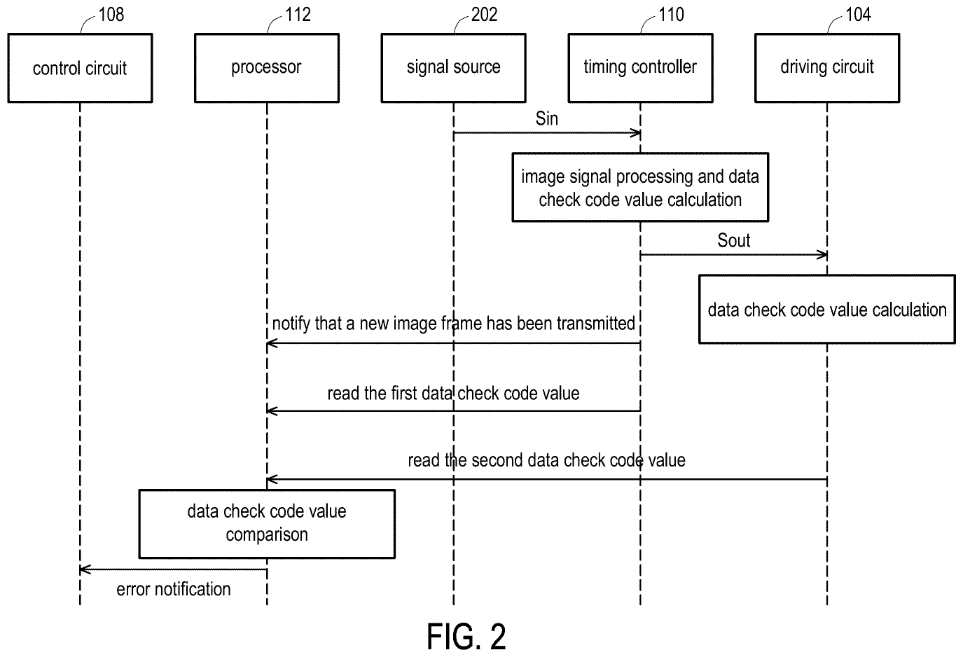

Furthermore, as shown in FIG. 1, the processing circuit 102 may include a timing controller 110 and a processor 112. The timing controller 110 is coupled to the driving circuit 104 and the processor 112, while the processor 112 is coupled to the control circuit 108. As illustrated in FIG. 2, the timing controller 110 may receive an input image signal Sin from a signal source 202, perform image processing on the input image signal Sin to convert it into an image format suitable for the driving circuit 104, thereby generating an output image signal Sout, and calculate the first data check code value. The signal source 202 may be, for example, a camera, but is not limited to this. The driving circuit 104 may calculate the second data check code value based on the received output image signal Sout. In addition, the timing controller 110 also notifies the processing circuit 102 that a new image frame has been transmitted, allowing the processor 112 to read the first data check code value calculated by the timing controller 110 and the second data check code value calculated by the driving circuit 104, and compare the first data check code value with the second data check code value. When the first data check code value is different from the second data check code value, the processor 112 sends an error notification to the control circuit 108, causing the control circuit 108 to close the display device 100.

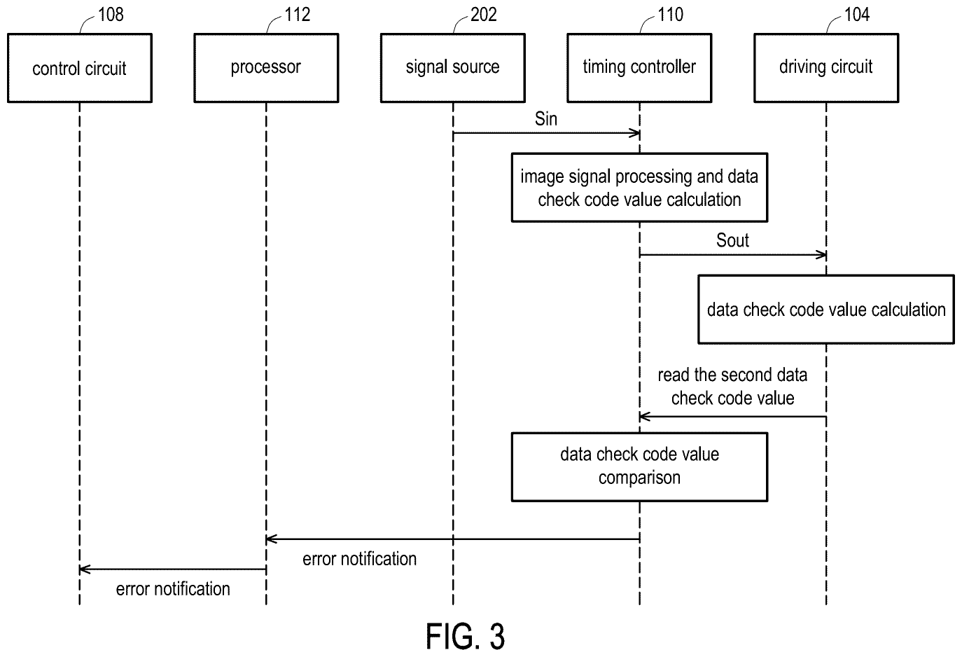

It is worth noting that, in other embodiments, the comparison operation between the first data check code value and the second data check code value may also be performed by the timing controller 110. As shown in FIG. 3, the timing controller 110 may compare the first data check code value it calculates with the second data check code value calculated by the driving circuit 104, and when the first data check code value is different from the second data check code value (representing that the output image signal Sout received by the driving circuit 104 is different from the output image signal Sout provided by the timing controller 110), send an error notification to the processor 112, which then sends an error notification to the control circuit 108, causing the control circuit 108 to close the display device 100.

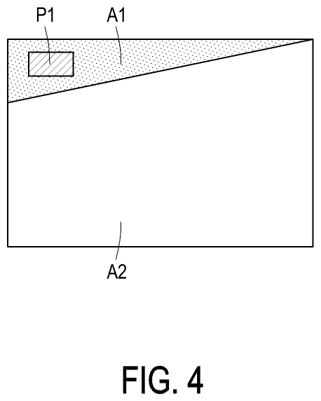

In addition, in some embodiments, the output image signal Sout may include a preset pattern image, and the preset data check code value corresponding to the preset pattern image may serve as the aforementioned first data check code value. The preset data check code value may be stored, for example, in the timing controller 110 or the processor 112, thereby eliminating the step of calculating the first data check code value. As shown in FIG. 4, the preset pattern image P1 may be displayed, for example, in the display area Al blocked by the mechanical component of the display device 100, and not displayed in the display area A2 where the user can view the image frame.

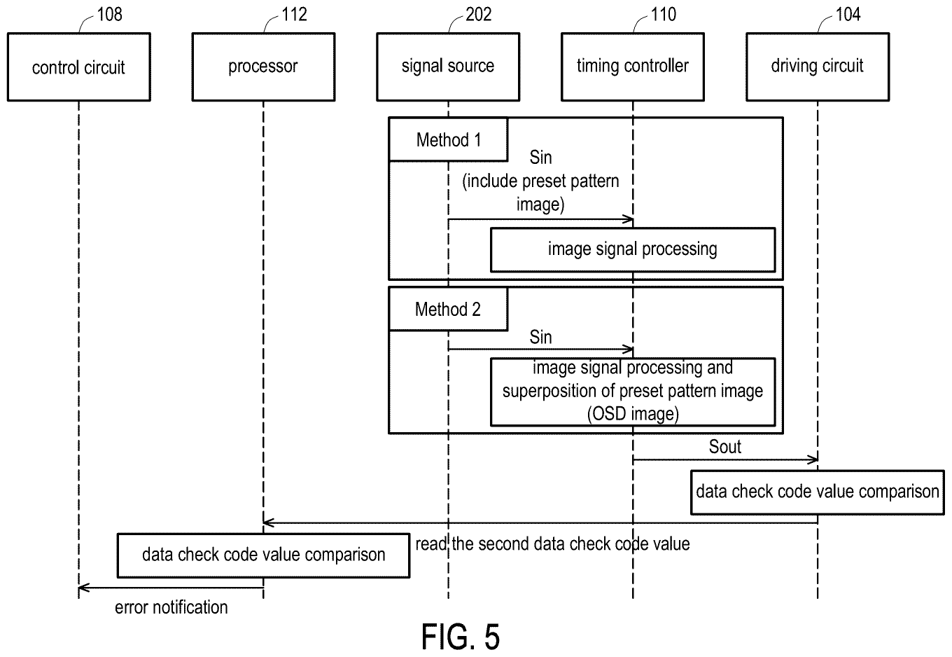

The way to include the preset pattern image P1 in the output image signal Sout may be as shown in FIG. 5, by having the input image signal Sin itself include the preset pattern image P1 (method 1), or the input image signal Sin itself does not include the preset pattern image P1, but the timing controller 110 generates the preset pattern image P1 using an On Screen Display (OSD) image, and superimposes the preset pattern image P1 on the input image signal Sin to make the output image signal Sout include the preset pattern image P1 (method 2). The driving circuit 104 may calculate the data check code value based on the preset pattern image P1 in the received output image signal Sout, to serve as the second data check code value. The processor 112 may then compare its stored first data check code value (preset data check code value) with the second data check code value (data check code value of the preset pattern image P1) calculated by the driving circuit 104, to determine whether the output image signal Sout received by the driving circuit 104 is the same as the output image signal Sout provided by the timing controller 110. When the first data check code value is different from the second data check code value, the processor 112 sends an error notification to the control circuit 108, causing the control circuit 108 to close the display device 100.

It is worth noting that the aforementioned preset pattern image P1 may be, for example, an image with a highest grayscale value or a lowest grayscale value of the display device 100, such as setting the grayscale values of all three R, G, B channels to 255 or 0, but is not limited to this. This is to avoid changes in the data check code value after the timing controller 110 performs dithering processing on the input image signal Sin, which may cause inconsistency in the preset data check code value.

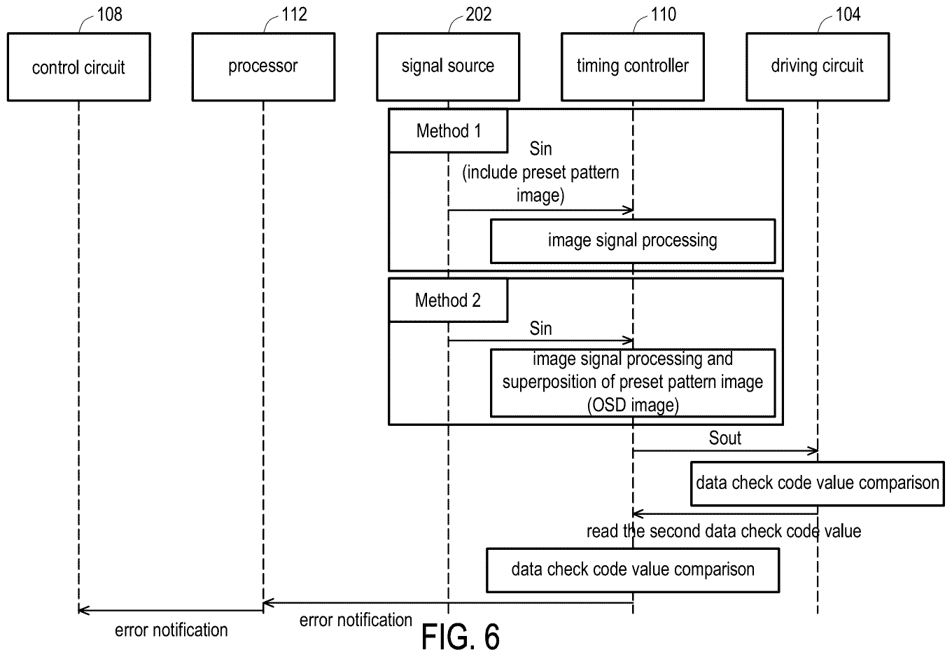

Similarly, in other embodiments, the comparison operation of the first data check code value and the second data check code value in the embodiment of FIG. 5 may also be performed by the timing controller 110. As shown in FIG. 6, the timing controller 110 may compare its stored first data check code value (preset data check code value) with the second data check code value (data check code value of the preset pattern image P1) calculated by the driving circuit 104, and when the first data check code value is different from the second data check code value, send an error notification to the processor 112, which then sends an error notification to the control circuit 108, causing the control circuit 108 to close the display device 100.

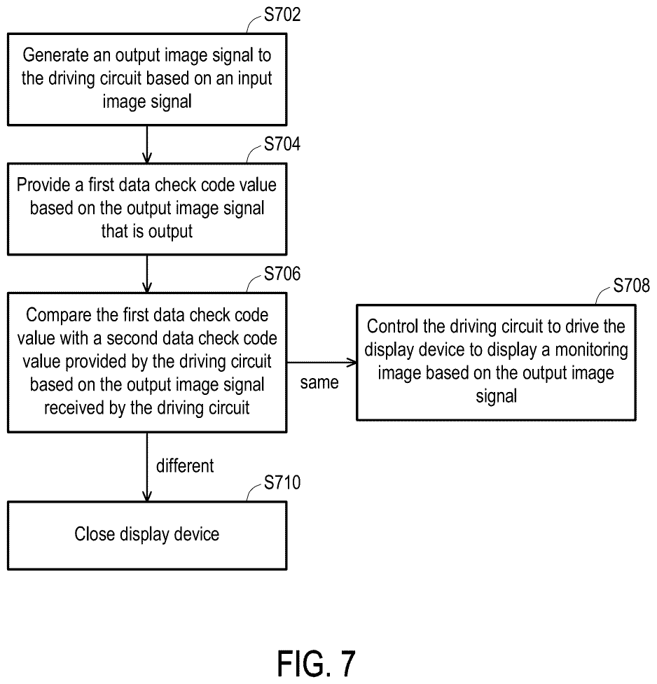

FIG. 7 is a flowchart of an image detecting method of an image monitoring system according to an embodiment of the present invention, wherein the image monitoring system includes a display device and a driving circuit, and the driving circuit is coupled to the display device. As can be seen from the above embodiments, the image detecting method of the image monitoring system may include at least the following steps. First, generate an output image signal to the driving circuit based on an input image signal (step S702). Next, provide a first data check code value based on the output image signal that is output (step S704), wherein the first data check code value may be, for example, calculated based on the output image signal that is output, or obtained from the preset pattern image included in the output image signal that is output. In other words, the first data check code value may be, for example, a preset data check code value corresponding to the preset pattern image, and the preset pattern image may be, for example, included in the input image signal, or the preset pattern image may be an On-Screen Display image, by superimposing the preset pattern image on the input image signal to generate an output image signal with the preset pattern image. In some embodiments, the preset pattern image may be displayed in a display area blocked by a mechanical component of the display device. Furthermore, the preset pattern image may be an image with a highest grayscale value or a lowest grayscale value, but is not limited thereto. Then, compare the first data check code value with a second data check code value provided by the driving circuit based on the output image signal received by the driving circuit (step S706), wherein the second data check code value may be, for example, calculated by the driving circuit based on the received output image signal, or calculated by the driving circuit based on the preset pattern image in the received output image signal. When it is compared that the first data check code value is the same as the second data check code value, it represents that the output image signal received by the driving circuit is the same as the output image signal, and the driving circuit may be controlled to drive the display device to display a monitoring image based on the output image signal (step S708). On the contrary, when it is compared that the first data check code value is different from the second data check code value, the display device is closed (step S710) to avoid providing an erroneous monitoring image to the user. In some embodiments, the display device may be, for example, a display device with a semi-transparent mirror in the display area. When the display device displays the screen normally, the monitoring image may be displayed in the display area, and when the display device 100 is closed, a reflective mirror surface is provided in the display area to avoid erroneous monitoring images affecting the security of the image monitoring system, wherein the display device may be, for example, a rearview mirror of a car or motorcycle, or a safety traffic mirror, but is not limited thereto.

In summary, the embodiment of the present invention may provide a first data check code value based on the output image signal, and compare the first data check code value with a second data check code value provided by the driving circuit based on the received output image signal, to confirm the correctness of the output image signal received by the driving circuit, thereby ensuring that the driving circuit drives the display device to display the correct image frame based on the output image signal.

1. An image monitoring system, comprising:
a display device;
a processing circuit, generating an output image signal according to an input image signal, wherein the output image signal comprises a preset pattern image;
a driving circuit, coupled to the display device, driving the display device to display a monitoring image according to the output image signal, wherein the processing circuit provides a first data check code value according to the preset pattern image of the output image signal output by the processing circuit, and compares the first data check code value with a second data check code value provided by the driving circuit, wherein the second data check code value is provided according to the preset pattern image of the output image signal received by the driving circuit; and
a control circuit, coupled to the processing circuit, wherein in response to the first data check code value being different from the second data check code value, the control circuit closes the display device,
wherein the preset pattern image is displayed in a first display area located outside a second display area of the display device, the second display area being an active viewing area for displaying the monitoring image of the display device, and the first display area being not visible to a user.

2. The image monitoring system as claimed in claim 1, wherein the processing circuit comprises:
a processor, coupled to the control circuit; and
a timing controller, coupled to the processor, generating the output image signal according to the input image signal, calculating the first data check code value, wherein the processor or the timing controller compares the first data check code value with the second data check code value, and in response to the first data check code value being different from the second data check code value, the processor notifies the control circuit to close the display device.

3. The image monitoring system as claimed in claim 2, wherein the first data check code value is a preset data check code value corresponding to the preset pattern image.

4. The image monitoring system as claimed in claim 3, wherein the preset pattern image is an On-Screen Display image displayed on the screen, and the timing controller superimposes the preset pattern image on the input image signal to generate the output image signal.

5. (canceled)

6. The image monitoring system as claimed in claim 3, wherein the preset pattern image is an image having a highest grayscale value or a lowest grayscale value.

7. The image monitoring system as claimed in claim 1, wherein after the control circuit closes the display device, the display area of the display device presents a mirror surface.

8. The image monitoring system as claimed in claim 1, wherein the control circuit is an embedded controller.

9. A image detection method of an image monitoring system, the image monitoring system comprising a display device, the image detection method of the image monitoring system comprising:
generating an output image signal to a driving circuit according to an input image signal, wherein the output image signal comprises a preset pattern image;
providing a first data check code value according to the preset pattern image of the output image signal that is output;
comparing the first data check code value with a second data check code value provided by the driving circuit, wherein the second data check code value is provided according to the preset pattern image of the output image signal received by the driving circuit;
in response to the first data check code value being the same as the second data check code value, controlling the driving circuit to drive the display device to display a monitoring image according to the output image signal; and
in response to the first data check code value being different from the second data check code value, closing the display device,
wherein the preset pattern image is displayed in a first display area located outside a second display area of the display device, the second display area being an active viewing area for displaying the monitoring image of the display device, and the first display area being not visible to a user.

10. The image detection method of the image monitoring system as claimed in claim 9, wherein the first data check code value is calculated according to the output image signal that is output.

11. The image detection method of the image monitoring system as claimed in claim 9, wherein the first data check code value is a preset data check code value corresponding to the preset pattern image.

12. The image detection method of the image monitoring system as claimed in claim 11, wherein the preset pattern image is an On-Screen Display image, the image detection method of the image monitoring system further comprising:
superimposing the preset pattern image on the input image signal to generate the output image signal.

13. (canceled)

14. The image detection method of the image monitoring system as claimed in claim 11, wherein the preset pattern image is an image having a highest grayscale value or a lowest grayscale value.

15. The image detection method of the image monitoring system as claimed in claim 9, wherein after closing the display device, the display area of the display device presents a mirror surface.
